(19) United States
(12) Patent Application Publication
(10) Pub. No.: US 2025/0370974 A1
(43) Pub. Date: Dec. 4, 2025

(54) APPLIED PROGRAMMATIC DATA LAKE ANALYSIS

(71) Applicant: Disney Enterprises, Inc., Burbank, CA (US)

(72) Inventors: Mark F. SENERTH, Weatogue, CT (US); Ryan A. WILLIAMS, Brooklyn, NY (US); Shahab YUNUS, New York, NY (US); James J. CHEONG, Chatham, NJ (US)

(21) Appl. No.: 18/677,529

(22) Filed: May 29, 2024

(51) Int. Cl. G06F 16/22

(52) U.S. Cl. CPC G06F 16/2228

(57) ABSTRACT

Techniques for identifying and applying data relationships. These techniques include retrieving log data relating to data stored in a plurality of electronic repositories. The techniques further include transforming the log data to generate structured table data, including matching a pattern in the log data to generate the structured table data, and identifying a plurality of data relationships for the data stored in the plurality of electronic repositories. This includes identifying metadata associated with the data stored in a plurality of electronic repositories, and correlating the generated structured table data with the associated metadata. The techniques further include applying the identified plurality of data relationships to at least one of: (i) modify operation of a computer software job operating on the data stored in the plurality of electronic repositories or (ii) identify for removal a portion of the data stored in a plurality of electronic repositories.

### BACKGROUND

Managing and optimizing large-scale electronic data storage (e.g., large-scale data lakes) is a challenging problem. For example, failure to identify redundant, unused, or rarely-used data can result in excessive and inefficient data storage and management. Further, improperly managed electronic data storage can increase computational burdens for a variety of applications, and can pose security and compliance risks.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 is a block diagram illustrating a computing environment for applied programmatic data lake analysis, according to at least one embodiment.

FIG. 2 is a block diagram illustrating a controller environment for applied programmatic data lake analysis, according to at least one embodiment.

FIG. 3 is a flowchart illustrating applied programmatic data lake analysis, according to at least one embodiment.

FIG. 4 illustrates transforming log data to identify tables and generate metrics, according to at least one embodiment.

FIG. 5 is a flowchart illustrating programmatically identifying data relationships, according to at least one embodiment.

FIGS. 6A-C illustrate example data lineage graphs for programmatically identified data relationships, according to at least one embodiment.

### DETAILED DESCRIPTION

Effectively managing large-scale data storage can raise a variety of problems. For example, many existing systems have inadequate analysis of data utilization. These systems lack depth in analyzing what data exists (e.g., in a cloud-based or on-premise data lake) and how stored data is being utilized, leading to inefficient data management. As another example, existing systems frequently have challenges in identifying redundant data. These systems can make it difficult to identify data that is obsolete or seldom accessed, resulting in unnecessary storage and incurred costs.

Further, many existing systems have limited insight into data access patterns. Organizations implementing these systems can struggle with a lack of detailed understanding of data access trends, including who accesses the data, what is being accessed, how far back data is accessed, and the frequency of access. Problems can further include suboptimal data storage optimization (e.g., failure to effectively support decision making for data archiving, deletion, or retention, for controlling expanding storage needs), and operational inefficiencies and compliance risks (e.g., failure to address potential risks in data security and regulatory compliance due to ineffective data management).

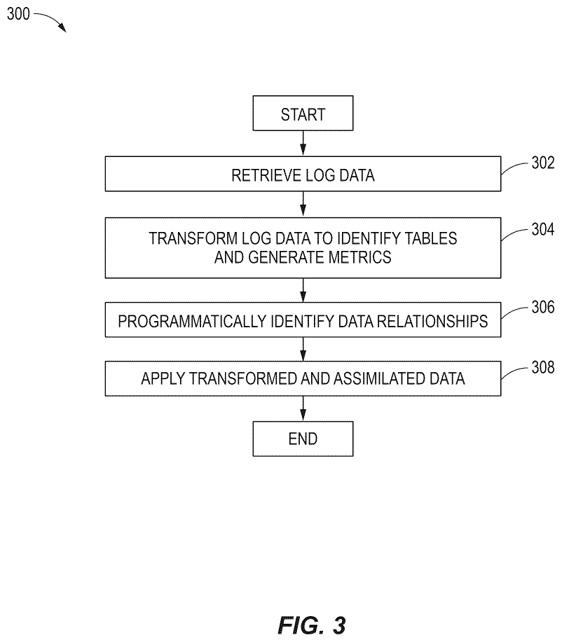

One or more techniques disclosed herein address aspects of these problems. For example, an improved extract, transform, load (ETL) engine can be used for expanded analysis and improvement of data storage (e.g., data lakes) by leveraging access logs and inventory logs. This is discussed further, below, with regard to FIG. 3. In an embodiment, this provides for enhanced data utilization analysis, by performing in-depth analysis of data usage patterns. This can lead to improved data management and use of data assets. Further, in an embodiment, the techniques disclosed herein can provide for effective identification of extraneous data, by enabling precise identification of underutilized or obsolete data. This can allow for strategic data lifecycle decisions (e.g., removal of unnecessary or extraneous data), reducing data storage needs.

One or more embodiments disclosed herein can further provide detailed data access insights, by providing granular insights into data access patterns. This can allow for improved decision making regarding data retention, archiving, and deletion, including improved fidelity for data insights and improvements to data auditing. Further, one or more embodiments provide for improved storage resource management (e.g., providing a clearer picture of data value compared with resources used, allowing for more accurate decisions regarding data storage) and improved operational efficiency and compliance (e.g., streamlining data management processes can enhance operational efficiency, reduce security risks, and ensure compliance with data regulations). In summary, one or more techniques disclosed herein provide for an improved approach to data management, leveraging an improved ETL engine and aggregate tables to provide for high-performing, efficient, and secure data management.

One or more techniques disclosed herein provide significant technical advantages. For example, enhanced data utilization analysis can be used to improve data management, reducing the amount of data stored (e.g., a data lake). This reduces needed memory and improves computational efficiency, by avoiding performing computation using redundant or unnecessary data. For example, a given job operating on a data storage location (e.g., a table or combination of tables) will be much more computationally efficient when operating on efficiently managed data (e.g., a query on a table generally runs more quickly if the table contains only recent historical data). Further, one or more aspects of enhanced data utilization analysis provide for improved security by limiting storage of sensitive information. This both reduces security risks and alleviates the need for computationally expensive security management and tracking (e.g., by reducing the quantity of sensitive data maintained in storage and limiting the number of storage locations for sensitive data).

Further, improved data access insights can provide a wide variety of technical improvements, including improved operational stability (e.g., powering an automated data dictionary, identifying who to notify in case of an outage or planned modification, or any other suitable improvement), improved cost attribution (e.g., computational cost attribution), improved data governance and security, and architectural simplification (e.g., identification of redundant or unnecessary tables). These are discussed further, below, with regard to block 308 illustrated in FIG. 3.

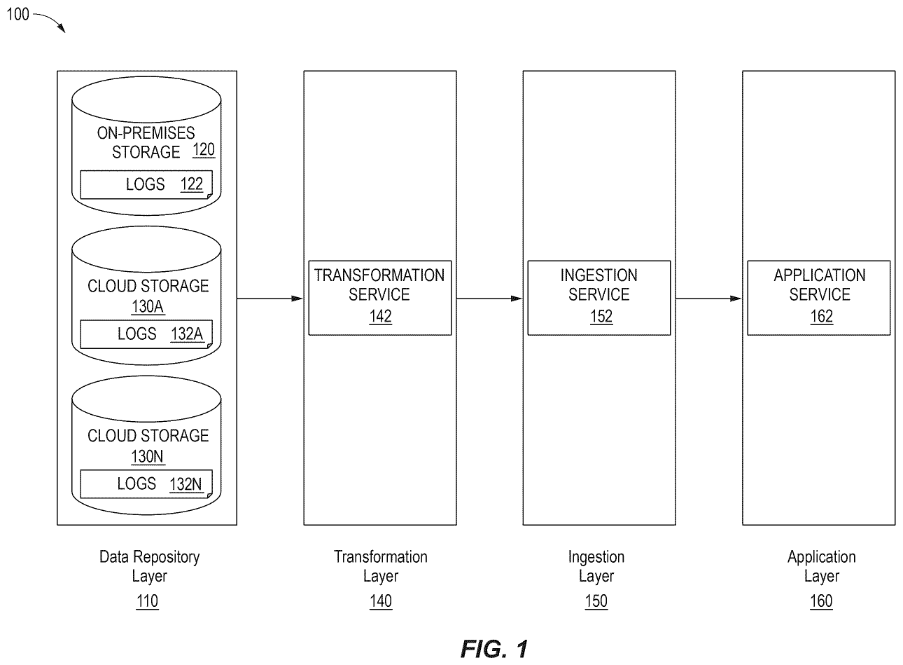

FIG. 1 is a block diagram illustrating a computing environment 100 for applied programmatic data lake analysis, according to at least one embodiment. In an embodiment, a data repository layer 110 includes a number of storage repositories. For example, the data repository layer 110 can include an on-premises storage repository 120. As another example, the data repository layer 110 can include one or more cloud storage repositories 130A-N. As one example, the cloud storage 130A could be a public cloud system, while the cloud storage 130N could be a private cloud or hybrid cloud system. These are merely examples, and any suitable number and type of storage repositories can be used.

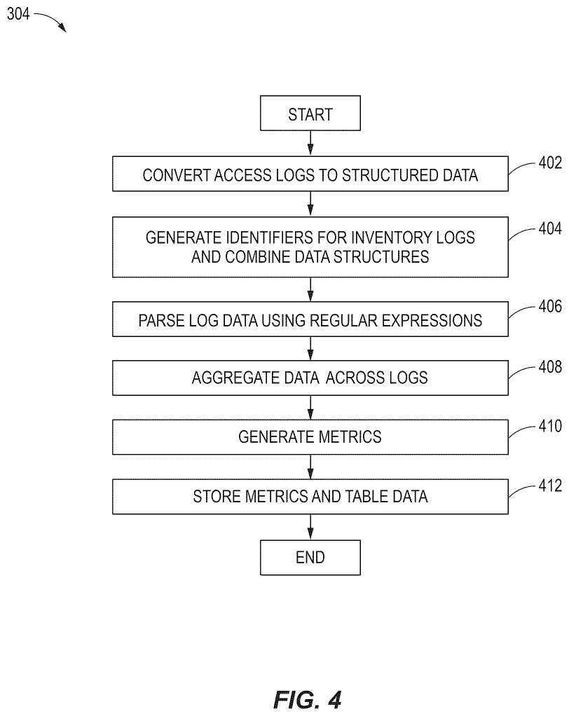

In an embodiment, each of the storage repositories 120, 130A, and 130N, in the data repository layer 110, includes one or more logs. For example, the on-premises storage 120 can include logs 122. These can include access logs, inventory logs, or any other suitable logs. As another example, the cloud storage 130A can include one or more logs 132A (e.g., access logs, inventory logs, or any other suitable logs). Further, the cloud storage 130N can include one or more logs 132N (e.g., access logs, inventory logs, or any other suitable logs). The logs 122, 132A, and 132N are discussed further, below, with regard to FIG. 4, and are merely examples for illustration.

In an embodiment, a transformation layer 140 includes a transformation service 142. For example, the transformation service 142 can be a software service that transforms the logs (e.g., any combination of the logs 122, 132A, and 132N) into tables. In an embodiment, the transformation service 142 can intake and clean up the logs into a table, and the table can be used to derive key info about the data maintained in the data repository layer 110. This is discussed further, below, with regard to FIGS. 3-4. For example, the transformation service 142 can intake and transform access logs and inventory logs, to generate one or more transformed tables. These transformed tables can be used to provide insight into data stored in the data repository layer 110, and access to data stored in the data repository layer 110.

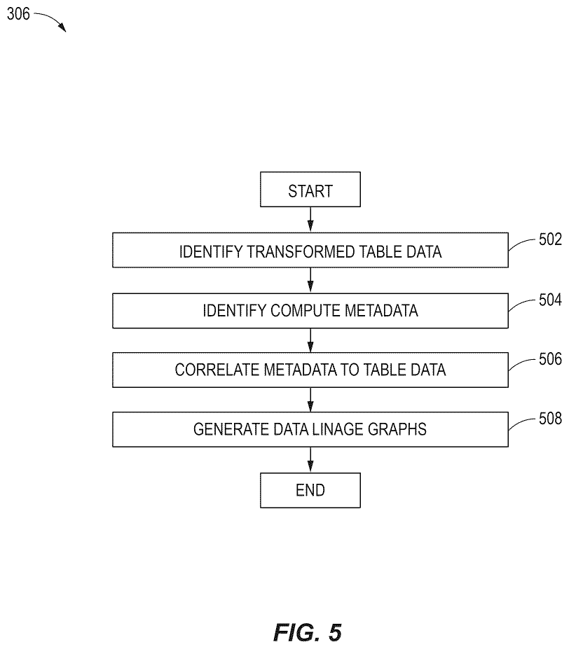

Further, in an embodiment an ingestion layer 150 includes an ingestion service 152. For example, the ingestion service 152 can be a software service that ties together multiple disparate datasets (e.g., generated using the transformation layer 140) and ingests that data into one or more centralized graphs that can be used for data analysis applications. In an embodiment, the ingestion service 152 makes inferences about datasets and generates connections between nodes and edges. For example, the ingestion service 152 can correlate metadata (e.g., internet protocol (IP) addresses) across datasets to programmatically identify data relationships and generate one or more centralized graphs. This is discussed further, below, with regard to FIGS. 3 and 5.

In an embodiment, an application layer 160 includes an application service 162. For example, the application service 162 can implement one or more software applications to analyze data and provide data insights (e.g., based on the ingested data generated by the ingestion layer 150). In an embodiment, the application service 162 can implement applications to improve operational stability (e.g., identifying job dependencies in a data environment), attribute costs (e.g., computational or monetary costs), simplify data architecture, visualize access patterns, or any other suitable applications. This is discussed further, below, with regard to FIG. 3.

In an embodiment, the various components of the computing environment 100 communicate using one or more suitable communication networks, including the Internet, a wide area network, a local area network, or a cellular network, and uses any suitable wired or wireless communication technique (e.g., WiFi or cellular communication). Further, in an embodiment, the data repository layer 110, transformation layer 140, ingestion layer 150, and application layer 160 can be implemented using any suitable combination of physical computing systems, including cloud compute nodes and storage locations or any other suitable implementation.

For example, the data repository layer 110, transformation layer 140, ingestion layer 150, and application layer 160 could each be implemented using a respective server or cluster of servers (e.g., one or more on-premises servers). As another example, the data repository layer 110, transformation layer 140, ingestion layer 150, and application layer 160 can be implemented using a combination of compute nodes and storage locations in a suitable cloud environment. For example, one or more of the components of the data repository layer 110, transformation layer 140, ingestion layer 150, and application layer 160 can be implemented using a public cloud, a private cloud, a hybrid cloud, or any other suitable implementation.

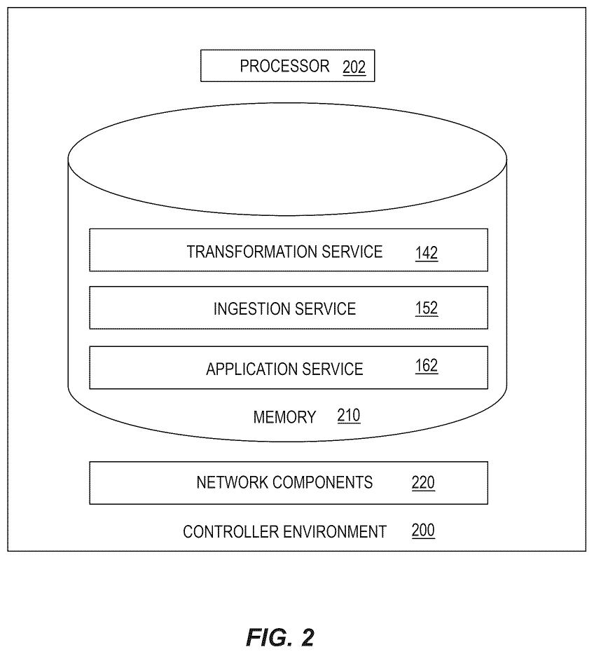

FIG. 2 is a block diagram illustrating a controller environment 200 for applied programmatic data lake analysis, according to at least one embodiment. In an embodiment, the controller environment 200 corresponds with one or more aspects of the data repository layer 110, transformation layer 140, ingestion layer 150, and application layer 160 illustrated in FIG. 1. The controller environment 200 includes a processor 202, a memory 210, and network components 220. The processor 202 generally retrieves and executes programming instructions stored in the memory 210. The processor 202 is included to be representative of a single central processing unit (CPU), multiple CPUs, a single CPU having multiple processing cores, graphics processing units (GPUs) having multiple execution paths, and the like.

The network components 220 include the components necessary for the controller environment 200 to interface with components over a network (e.g., as illustrated in FIG. 1). For example, the controller environment 200 can be a part of any, or all, of the data repository layer 110, transformation layer 140, ingestion layer 150, and application layer 160, and the controller environment 200 can use the network components 220 to interface with remote storage and other compute nodes using the network components.

The controller environment 200 can interface with other elements in the system over a local area network (LAN), for example an enterprise network, a wide area network (WAN), the Internet, or any other suitable network. The network components 220 can include wired, WiFi or cellular network interface components and associated software to facilitate communication between the controller environment 200 and a communication network.

Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory. The memory 210 generally includes program code for performing various functions related to use of the controller environment 200. The program code is generally described as various functional “applications” or “services” within the memory 210, although alternate implementations may have different functions and/or combinations of functions.

Within the memory 210, a transformation service 142 facilitates transforming logs (e.g., any combination of the logs 122, 132A, and 132N illustrated in FIG. 1) into tables. The ingestion service 152 facilitates tying together multiple disparate datasets (e.g., generated using the transformation service 142) and ingesting that data (e.g., metadata and table data) into one or more graphs (e.g., data lineage graphs) that can be used for data analysis applications. The application service 162 facilitates analyzing data and providing data insights (e.g., based on the ingested data generated by the ingestion service 152). This is discussed further, below, with regard to FIG. 3.

Although FIG. 2 depicts the transformation service 142, the ingestion service 152, and the application service 162 as located in the memory 210, that representation is merely provided as an illustration for clarity. More generally, the controller environment 200 may include one or more computing platforms, such as computer servers for example, which may be co-located, or may form an interactively linked but distributed system, such as a cloud-based system (e.g., a public cloud, a private cloud, a hybrid cloud, or any other suitable cloud-based system). As a result, the processor 202 and memory 210 may correspond to distributed processor and memory resources within a computing environment.

FIG. 3 is a flowchart 300 illustrating applied programmatic data lake analysis, according to at least one embodiment. At block 302, a transformation service (e.g., the transformation service 142 illustrated in FIGS. 1-2), retrieves log data. In an embodiment, one or more data repositories (e.g., the on-premises storage 120, cloud storage 130A, and cloud storage 130N illustrated in FIG. 1) can be associated with one or more logs (e.g., the logs 122, 132A, and 132N illustrated in FIG. 1). These logs can include access logs, inventory logs, or any other suitable logs.

For example, data access logs can contain various data points that are collected upon any interaction with an object, or file, or network, on a system that houses objects or files. Each time a user or machine interacts with an object or file a log entry is created recording the type of operation with the object, and information about the caller. For example, cloud compute access logs may identify a container (e.g., a bucket), a time, a remote IP address, a request identifier, an operation, a key, bytes sent, object size, a total time, or any other suitable information. These are merely examples, and the logs can include any suitable data. In an embodiment, however, the access logs do not have the information needed to attribute a given operation to a tangible entity (e.g., a business team, person, or other suitable tangible entity). This type of information is typically stored where a user or machine is accessing the data. As discussed further, below, with regard to block 306 and FIG. 5 compute metadata can be used to correlate log data with one or more entities associated with the logged operation (e.g., using an IP address).

At block 304, the transformation service transforms the logs to identify tables. For example, the transformation service can convert raw, unstructured access logs into a structured and enriched format to use for additional processing and analysis. Further, the transformation service can parse inventory logs, extracting data from object keys to build identifiers and using regular expression (regex) pattern matching to parse the inventory log data to formulate and identify logical tables (e.g., groupings of files). The transformation service can then aggregate data (e.g., across the access and inventory logs) and store the resulting data for further use downstream.

For example, the transformation service can ingest and clean up access logs and store the access logs in a suitable table. That table can be used to derive key info and calculate interim metrics. In parallel (e.g., as part of a different flow), the transformation service can process inventory logs to identify interim outputs for the inventory logs. The transformation service can join, and further process, the interim outputs from the access logs and inventory logs to generate an aggregation table. In an embodiment, the metrics can include a minimum partition date (e.g., an earliest date partition for individual tables sourced from inventory logs), lookback days (e.g., the number of days between the date of a read operation and the relevant physical partition date of a table object that is being read, for those tables that actually have a date partition), lookback aggregate (e.g., a measure of how concentrated read operations are in relation to the age of the data for a given date-partitioned table), and any other suitable metrics. This is discussed further, below, with regard to FIG. 4.

At block 306, an ingestion service (e.g., the ingestion service 152 illustrated in FIGS. 1 and 2) programmatically identifies data relationships using the transformed data (e.g., the data transformed at block 302, above). As discussed above in relation to block 302, in an embodiment log data does not have the information needed to attribute a given operation to a tangible entity (e.g., a business team, person, or other suitable tangible entity) and generate a programmatic lineage. In an embodiment, the ingestion service can assimilate the transformed log-based dataset generated at block 304 with compute metadata to programmatically identify data relationships. For example, the ingestion service can use an IP address, or any other suitable compute metadata, to programmatically identify data relationships. This is discussed further, below, with regard to FIG. 5.

At block 308, an application service (e.g., the application service 162 illustrated in FIGS. 1 and 2) applies the transformed and assimilated data. In an embodiment, the application service can perform any number of suitable applications using the transformed and assimilated data (e.g., the data ingested at block 306). As one example, data metrics (e.g., identified at block 304) can be used to improve data management (e.g., by identifying unused or redundant data). This can allow for automated (or manual) processes to modify computer software jobs operating on the data, remove unnecessary data, change data management policies to avoid storing unnecessary data, and a wide variety of other applications. For example, the application service can automatically, without human intervention, modify one or more computer software jobs to operate on a different data source (e.g., a different table among a group of tables with redundant information), remove unnecessary or redundant data, or perform any other suitable action. As another example, the application service can automatically, without human intervention, identify for removal stored data (e.g., redundant or unnecessary data).

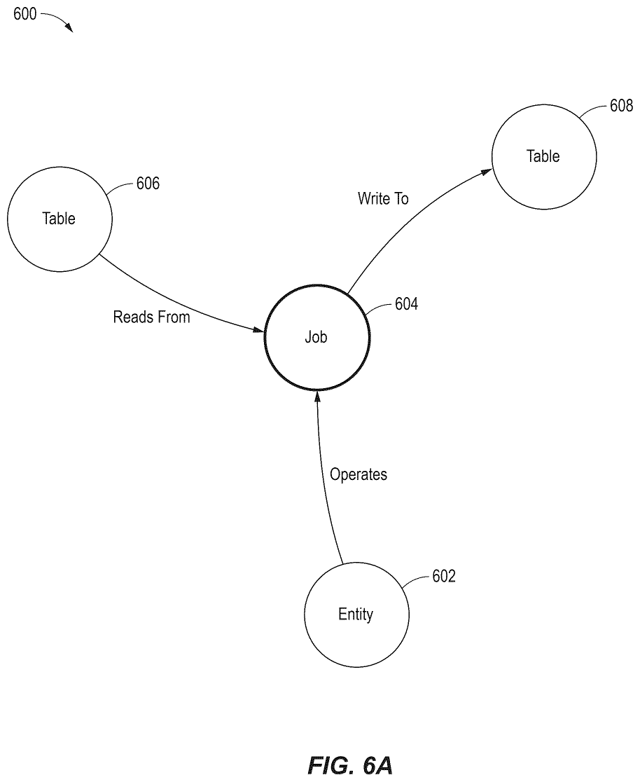

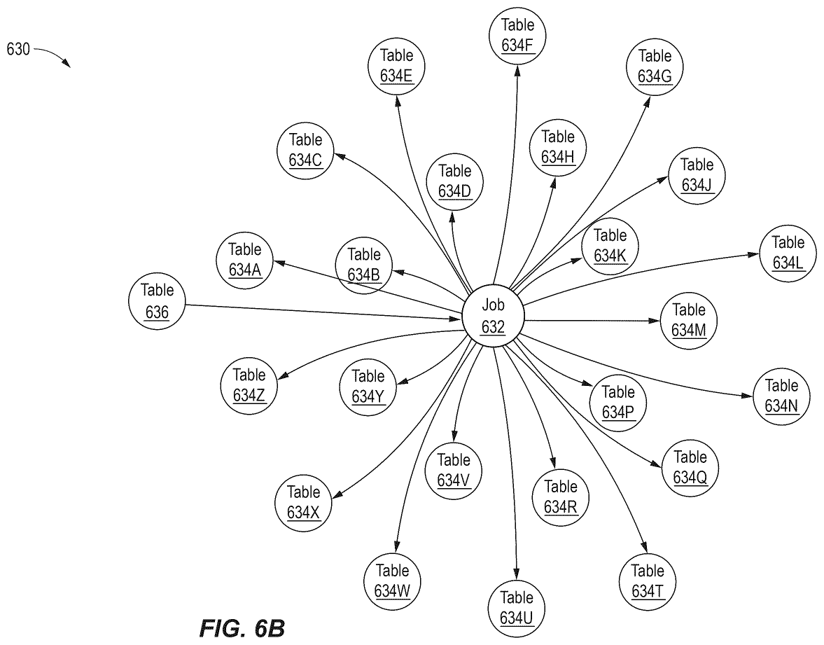

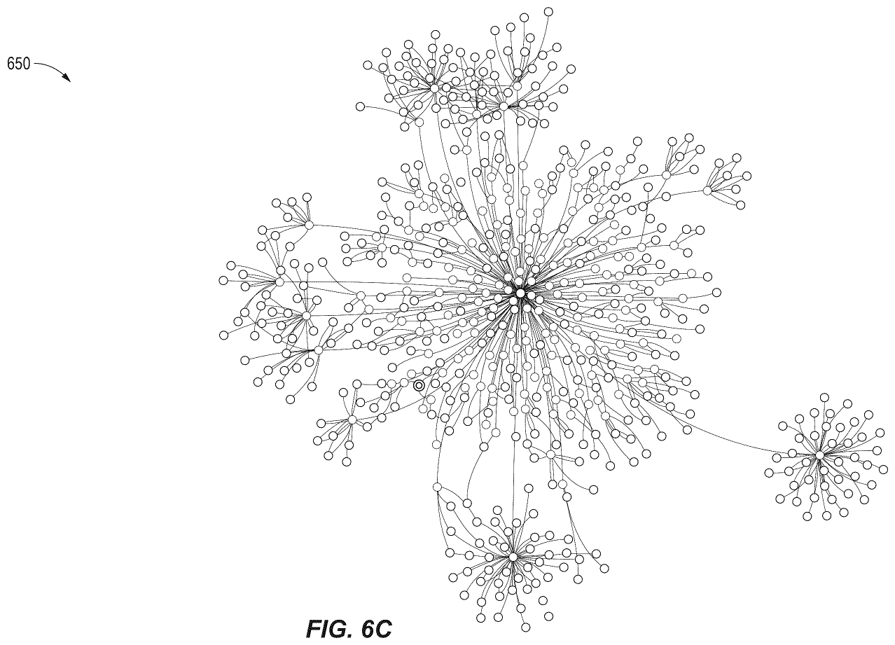

As another example, the programmatically identified relationships from block 306 can be used to generate a graph (e.g., by identifying vertices and edges for the graph). Example data lineage graphs are illustrated in FIGS. 6A-C. These graphs can be used for a wide variety of applications.

In an embodiment, the application service enhances operational stability using one or more generated graphs. For example, assume a computational job fails in a production environment. The job populates a table, which is relied upon by many downstream computational jobs, and the tables output of the downstream jobs are consumed by further downstream jobs recursively. Using the log data alone, the application service cannot identify the impact of this failed job on the downstream jobs. For example, a table could have billions, or even trillions, of rows, and a given job (e.g., a failed job) could be dozens of hops away from a relevant table or downstream job. It is extremely burdensome, if not impossible, to analyze this circumstance based on log data alone, whether using automated analysis or human review. But using a generated graph (e.g., from block 306, above), the application service can identify the impact of the failed job multiple hops away from the original job and table. This enables automated, or human, actions to proactively remediate the issue, while the failed job is repaired. For example, another job can be re-run to automatically recover the impacted table. As another example, the application service can identify who to notify if there is a data set outage (e.g., based on identifying affected jobs and tables), or who to contact if there is a planned modification (e.g., decommissioning or modification of a dataset). These are merely examples, and any suitable action(s) can be taken. As another example, the application service can power an automated data dictionary. For example, the data dictionary can be self-evolving, auto-discoverable, and auto-documentable, and can be used to facilitate a wide variety of improvements.

As another example, in modern development environments it is generally a manual process to determine which dependencies are in the critical path of which end product. For example, an engineer may need to manually inquire (e.g., through open communication channels) of a large department to identify who uses a particular table to job. This is extremely time consuming and inefficient, and engineering resources are needed to monitor tasks and provide appropriate metrics, alerts, and repairs. In an embodiment, the application service can use a generated graph to programmatically and mechanically identify all dependencies leading to a product or feature (e.g., upstream dependencies). This allows for prioritized alerts, monitoring, maintenance, and repairs, among other suitable tasks, based on the criticality of various jobs.

In an embodiment, the application service can further use the generated graph (e.g., generated at block 306) for end product cost attribution. This can include both computational cost (e.g., compute usage, data storage usage, and any other suitable computational cost) and monetary cost. For example, without the generated graph the application service cannot readily determine the cost for an individual product or feature (e.g., the summation of all computational costs or monetary costs for all jobs related to that product or feature) across all upstream dependencies. The application service can use the generated graph to identify cost (e.g., automatically identify linked together weighted computational cost, without human intervention) for any given product or feature (e.g., a cost-weighted average of all jobs and tables used to implement the respective product or feature).

In an embodiment, the application service can further use the generated graph (e.g., generated at block 306) for improved data governance and security. For example, raw log data may, in some circumstances, be used for data attribution in a system (e.g., to identify personal information (PI) or personally identifiable information (PII) subject to governance and security requirements). This is challenging because data is inherently leaky, being replicated to many locations in the object storage system. Log based attribution is ineffective, inaccurate, and cost prohibitive in terms of engineering time, computational burden, or both. The application service can use the generated graph to identify and monitor critical datasets and the propagation and generation of new data from the critical datasets (e.g., datasets that contain PI or PII). For example, the application service can use the generated graph to identify all teams and jobs that query critical datasets, the datasets they produce when querying the critical datasets multiple hops away from origination, and can set up alerts and security enhancements for these teams, jobs, and datasets.

Further, in an embodiment, the application service can use a generated graph for architectural simplification. Typically, without a generated graph, viewing an entire environment is a manual process, and is very challenging. The application service can use the generated graph to identify which teams and jobs access which tables and relate to which upstream or downstream jobs, allowing for automated or human architectural simplification. For example, the application service can identify teams that are producing duplicate datasets (e.g., without realizing the datasets are duplicate), can identify a common ancestor, and can combine the datasets to avoid duplication and save redundant storage and compute resources. This also saves engineering overhead, operational complexity, and generally results in a more reliable data platform.

FIG. 4 illustrates transforming log data to identify tables and generate metrics, according to at least one embodiment. In an embodiment, FIG. 4 corresponds with block 304 illustrated in FIG. 3. At block 402, a transformation service (e.g., the transformation service 142 illustrated in FIGS. 1-2) converts access logs to structured data. In an embodiment, the transformation service converts raw, unstructured, access logs into a structured and enriched format that is ready for additional processing and analysis.

For example, the transformation service can read a list of file paths from an inventory log snapshot (e.g., a latest inventory log snapshot) to identify a comprehensive list of files in storage, as of the time of the snapshot. The transformation service can then load access log data from these paths. In an embodiment, the transformation service narrows down the access log data to include only logs from the most recent complete data (e.g. prior to the snapshot time).

In an embodiment, the transformation service takes access log data, which is initially in a raw and unstructured format, and transforms the data into a structured format. The transformation service can use a schema (e.g., a pre-defined schema) for this transformation. The transformation service can, in an embodiment, enrich the data by extracting and parsing date and time information from the access logs, which can allow for a more detailed and time-sensitive analysis. Further, in an embodiment the transformation service writes the structured data to another table (e.g., a date partitioned table). This table can be used for further downstream processing, and post-hoc analysis, if needed.

In an embodiment, the transformation service further filters access log data (e.g., to focus on read operations). This can exclude system files and other unwanted data. Further, the transformation service can extract and construct a table prefix from the log file path. For example, the transformation service can identify a table prefix based on an assumption that any partition column in the path will have an “=” sign included in it.

At block 404, the transformation service generates identifiers for inventory logs and combines data structures. In an embodiment, for each set of inventory logs (e.g., across different accounts and containers), the transformation service reads the latest available snapshot (e.g., as discussed above in relation to block 402) and enriches the snapshot with identifiers. For example, the transformation service can add account identifier and inventory snapshot date information. Further, the transformation service can combine inventory data structures (e.g., inventory DataFrames) into a single data structure, accounting for any missing columns across different inventories. The transformation service can transform the combined data structure (e.g., the combined DataFrame) to extract information from object keys (e.g., akin to file paths) to build identifiers. This can include parsing and renaming columns and extracting base table paths and partition columns from keys.

At block 406, the transformation service parses log data using regular expressions. For example, the transformation service can use the datasets created at blocks 402 and 404, discussed above. In an embodiment, the transformation service creates a map of table prefixes to regex patterns. For example, the regex patterns can be used to correlate a file path (e.g., from a log) to a particular table. As one example, regex patterns can be used to parse out date partition information. In an embodiment, unique table prefixes (e.g., generated at block 402, above) can be collected with example path keys into a map. This can be used to prepare a table to regex map, where each table prefix is mapped to its applicable regex pattern. This allows us to identify the logical table ownership for each file in the object storage system. Further, in an embodiment regex patterns can be configured and modified over time. For example, new patterns can be found and old patterns can be deprecated. As one example, failed (e.g., un-parseable) logs can be maintained in a table, and can be used track and identify when regex patterns should be changed.

At block 408, the transformation service aggregates data across logs. In an embodiment, the transformation service aggregates data by account ID, container, table name, or any other suitable column. This is merely an example. Further, in an embodiment, output from intermediate calculations can be aggregated.

At block 410, the transformation service generates metrics. In an embodiment, the transformation service can generate a minimum partition date metric. This can include an earliest date partition for individual tables sourced from inventory logs. For example, the minimum partition date can be thought of as an oldest available date partition for any given table. In this example, a given table is identified by a combination of identifiers such as account number, bucket, table name, table prefix, or any other suitable identifiers. In an embodiment, the minimum partition date can be an interim metric used for further metrics. For example, a data structure (e.g., a DataFrame) containing minimum partition dates can be written to a table, partitioned, and used for further downstream analysis and processing.

In an embodiment, the transformation service can further generate a metric that describes a number of days between the date of a read operation and the relevant physical partition date of a table object that is being read, for those tables that actually have a date partition. This can be termed a “lookback days” metric. For example, assume the transformation service identifies a table that is partitioned by day (e.g., YYYY-MM-DD format for simplicity) and this table has data for the past three months. Assume a job performs a read operation on this table to identify behavior from one week earlier (i.e., seven days prior). For example, an error may have occurred, and the job may be seeking to identify the source of the error. This would result in a read operation on the relevant table, for a table partition associated with seven days prior. The look days metric for this event would be (day of event)−(day for target partition that is being read)=negative 7. This is merely an example. In an embodiment, the lookback days metric serves as an interim output used to calculate a lookback aggregate metric, discussed further below.

Further, in an embodiment, the transformation service can generate a lookback aggregate metric. This can include a metric termed a “lookback percentage concentration,” which provides a measure of how concentrated read operations are in relation to the age of the data for a given date-partitioned table. For example, the lookback percentage calculation can be generated by dividing the lookback days metric (discussed above), with the number of days based on a minimum partition date metric (also discussed above): (day of read operation event−day of physical partition being read)/(day of read operation event−day of oldest available partition). In an embodiment, a lookback aggregate metric can be used to identify how far back data in a table is actually used, to assist in managing the table (e.g., to allow removal of older data that is not frequently used).

While FIG. 4 illustrates generating metrics at block 410, this is merely an example, and any combination of metrics can be calculated as part of any block in FIG. 4 (e.g., one of the blocks 402, 404, 406, or 408). For example, as discussed above, a minimum partition date metric and lookback days metric can be stand-alone metrics, interim outputs used for calculation of a lookback aggregate metric, or any combination thereof.

At block 412, the transformation service stores the resulting metrics and data. In an embodiment, the transformation service stores the resulting data structure(s) and metric(s) to a suitable table, for use in downstream processing. In an embodiment, the data can be partitioned and configured for improved performance. Further, in an embodiment, only successful tables are stored for further use. For example, unsuccessful or partial tables can be discarded. As another example, as discussed above unsuccessful or partial tables can be maintained and used to identify new parsing patterns (e.g., regex patterns).

FIG. 5 is a flowchart illustrating programmatically identifying data relationships, according to at least one embodiment. In an embodiment, FIG. 5 corresponds with block 306 illustrated in FIG. 3. At block 502, an ingestion service (e.g., the ingestion service 152 illustrated in FIGS. 1-2) identifies transformed table data. For example, the ingestion service can identify transformed table data generated using FIG. 4.

At block 504, the ingestion service identifies compute metadata. In an embodiment, compute metadata is data that resides on a compute node that initiates an action with an object or file that is stored on a storage device. The compute metadata is generally applied generically and consistently for all things deployed within an environment and can include user augmented information and automatically generated information. For example, a team working in a data storage environment (e.g., a cloud computing environment) may add user augmented information, like metadata associating a deployed job to their team (e.g., for tracking purposes). As another example, each compute node includes automatically generated information (e.g., IP address, time, and any other suitable information).

In an embodiment, compute nodes (e.g., in a cloud environment) are ephemeral and are started and shut down frequently. This creates a challenge in identifying metadata, as metadata associated with a given compute node may not be accessible or available. This can be address by querying running compute nodes periodically and maintaining metadata in a time series table (or any other suitable storage location).

At block 506, the ingestion service correlates metadata to table data. For example, a transformation service (e.g., as discussed above in relation to FIG. 4) can aggregate reads and writes to data objects into a table, identifying the table. The ingestion service can correlate this table data with suitable metadata, including an IP address, one or more timestamps, user identifiers, application identifiers, or any other suitable metadata.

In an embodiment, the ingestion service correlates the table data with metadata through a windowing and joining technique. For example, the ingestion service can join table data using an IP address through a window in which that IP address remains the same. That is, for the duration of a time period at which the same IP address is interacting with one or more data objects, the ingestion service can join table data (e.g., across multiple tables) relating to those data objects. The IP address, and other suitable metadata, can be stored in suitable logs. As discussed above, an IP address is merely one example, and any suitable metadata can be used.

At block 508, the ingestion service generates data lineage graphs. In an embodiment, the programmatically identified data relationships (e.g., generated at blocks 502-506) can be used to generate data lineage graphs. For example, the ingestion service (or any other suitable software service) can programmatically create graphs by identifying nodes and edges (e.g., node and edge comma-separated value (CSV) files) from the programmatically identified data relationships. These nodes and edges can be used to create graphs. These graphs are illustrated further, below, with regard to FIGS. 6A-C.

FIGS. 6A-C illustrate example data lineage graphs for programmatically identified data relationships, according to at least one embodiment. For example, FIG. 6A illustrates a graph 600, in which an entity 602 operates a job 604. The job 604 reads data from a table 606 and writes data to another table 608. FIG. 6B illustrates another example graph 630. A job 632 reads data from a table 636. The job 632 then writes data to a number of tables 634A-Z. FIG. 6C illustrates another example graph 650, in which numerous jobs write from and read to numerous tables. In an embodiment, each of the graphs 600, 630, and 650 are presented using a suitable user interface in which a user can identify which jobs read from, and write to, which table (e.g., through a zoom or another suitable user interface feature) and other suitable information.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A computer-implemented method, comprising:
retrieving log data relating to data stored in a plurality of electronic repositories;
transforming the log data to generate structured table data, comprising:
matching a pattern in the log data to generate the structured table data;
identifying, using one or more computer processors, a plurality of data relationships for the data stored in the plurality of electronic repositories, comprising:
identifying metadata associated with the data stored in a plurality of electronic repositories; and
correlating the generated structured table data with the associated metadata; and
applying the identified plurality of data relationships to at least one of: (i) modify operation of a computer software job operating on the data stored in the plurality of electronic repositories or (ii) identify for removal a portion of the data stored in a plurality of electronic repositories.

2. The computer-implemented method of claim 1, wherein matching the pattern in the log data to generate the structured table data comprises:
applying a regular expression to the log data.

3. The computer-implemented method of claim 2, wherein applying the regular expression to the log data comprises:
identifying a map of table prefixes to regular expression patterns; and
parsing the log data using the map.

4. The computer-implemented method of claim 3, wherein the log data comprises both access log data and inventory log data, and wherein the regular expression patterns relate to date information.

5. The computer-implemented method of claim 1, wherein the metadata associated with the data stored in the plurality of electronic repositories comprise an internet protocol (IP) address.

6. The computer-implemented method of claim 5, wherein correlating the generated structured table data with the associated metadata comprises:
identifying a plurality of time windows in which a same IP address is interacting with one or more data objects; and
correlating the generated structured table data with associated IP addresses using the plurality of time windows.

7. The computer-implemented method of claim 1, wherein applying the identified plurality of data relationships comprises:
generating a graph based on the identified plurality of data relationships, the graph comprises a plurality of edges and a plurality of vertices reflecting the identified plurality of data relationships.

8. The computer-implemented method of claim 1, wherein applying the identified plurality of data relationships comprises:
automatically, without human intervention, modifying operation of the computer software job operating on the data stored in the plurality of electronic repositories, based on the identified plurality of data relationships.

9. The computer-implemented method of claim 1, wherein applying the identified plurality of data relationships comprises:
automatically, without human intervention, identifying for removal a portion of the data stored in the plurality of electronic repositories, based on the identified plurality of data relationships.

10. A non-transitory computer program product comprising:
one or more non-transitory computer readable media containing, in any combination, computer program code that, when executed by operation of any combination of one or more processors, performs operations comprising:
retrieving log data relating to data stored in a plurality of electronic repositories;
transforming the log data to generate structured table data, comprising:
matching a pattern in the log data to generate the structured table data;
identifying, using one or more computer processors, a plurality of data relationships for the data stored in the plurality of electronic repositories, comprising:
identifying metadata associated with the data stored in a plurality of electronic repositories; and
correlating the generated structured table data with the associated metadata; and
applying the identified plurality of data relationships to at least one of: (i) modify operation of a computer software job operating on the data stored in the plurality of electronic repositories or (ii) identify for removal a portion of the data stored in a plurality of electronic repositories.

11. The non-transitory computer program product of claim 10, wherein matching the pattern in the log data to generate the structured table data comprises:
applying a regular expression to the log data.

12. The non-transitory computer program product of claim 11, wherein applying the regular expression to the log data comprises:
identifying a map of table prefixes to regular expression patterns; and
parsing the log data using the map.

13. The non-transitory computer program product of claim 10,
wherein the metadata associated with the data stored in the plurality of electronic repositories comprise an internet protocol (IP) address, and
wherein correlating the generated structured table data with the associated metadata comprises:
identifying a plurality of time windows in which a same IP address is interacting with one or more data objects; and
correlating the generated structured table data with associated IP addresses using the plurality of time windows.

14. The non-transitory computer program product of claim 10, wherein applying the identified plurality of data relationships comprises:
automatically, without human intervention, modifying operation of the computer software job operating on the data stored in the plurality of electronic repositories, based on the identified plurality of data relationships.

15. The non-transitory computer program product of claim 10, wherein applying the identified plurality of data relationships comprises:
automatically, without human intervention, identifying for removal a portion of the data stored in the plurality of electronic repositories, based on the identified plurality of data relationships.

16. A system, comprising:
one or more processors; and
one or more memories storing a program, which, when executed on any combination of the one or more processors, performs operations, the operations comprising:
retrieving log data relating to data stored in a plurality of electronic repositories;
transforming the log data to generate structured table data, comprising:
matching a pattern in the log data to generate the structured table data;
identifying, using one or more computer processors, a plurality of data relationships for the data stored in the plurality of electronic repositories, comprising:
identifying metadata associated with the data stored in a plurality of electronic repositories; and
correlating the generated structured table data with the associated metadata; and
applying the identified plurality of data relationships to at least one of: (i) modify operation of a computer software job operating on the data stored in the plurality of electronic repositories or (ii) identify for removal a portion of the data stored in a plurality of electronic repositories.

17. The system of claim 16, wherein matching the pattern in the log data to generate the structured table data comprises:
applying a regular expression to the log data, comprising:
identifying a map of table prefixes to regular expression patterns; and
parsing the log data using the map.

18. The system of claim 16,
wherein the metadata associated with the data stored in the plurality of electronic repositories comprise an internet protocol (IP) address, and
wherein correlating the generated structured table data with the associated metadata comprises:
identifying a plurality of time windows in which a same IP address is interacting with one or more data objects; and
correlating the generated structured table data with associated IP addresses using the plurality of time windows.

19. The system of claim 16, wherein applying the identified plurality of data relationships comprises:
automatically, without human intervention, modifying operation of the computer software job operating on the data stored in the plurality of electronic repositories, based on the identified plurality of data relationships.

20. The system of claim 16, wherein applying the identified plurality of data relationships comprises:
automatically, without human intervention, identifying for removal a portion of the data stored in the plurality of electronic repositories, based on the identified plurality of data relationships.
